(19) United States
(12) Patent Application Publication
(10) Pub. No.: US 2026/0177872 A1
(43) Pub. Date: Jun. 25, 2026

(54) ARRAY SUBSTRATE AND DISPLAY PANEL

(71) Applicants: Chongqing BOE Optoelectronics Technology Co., Ltd., Chongqing (CN); BOE TECHNOLOGY GROUP CO., LTD., Beijing (CN)

(72) Inventors: Junming CHEN, Beijing (CN); Xiaoyuan WANG, Beijing (CN); Hui GUO, Beijing (CN); Xun PU, Beijing (CN); Jiandong GUO, Beijing (CN); Bin WAN, Beijing (CN); Guodong YANG, Beijing (CN); Chunyan QIN, Beijing (CN); Yi WANG, Beijing (CN); Chenchen FAN, Beijing (CN)

(21) Appl. No.: 18/850,139

(22) PCT Filed: Apr. 25, 2023
(86) PCT No.: PCT/CN2023/090509

§ 371 Date: Sep. 24, 2024

(51) Int. Cl. G02F 1/1368; G02F 1/1343

(52) U.S. Cl. CPC G02F 1/1368; G02F 1/134363

(57) ABSTRACT

An array substrate and a display panel are provided. The array substrate includes: a base substrate which includes a display region and a peripheral region surrounding the display region, pixel unit groups are arranged in the display region along a first direction, each pixel unit group includes pixel units arranged along a second direction, each including a thin film transistor. The array substrate further includes: gate lines arranged along the first direction, wherein each gate line extends along the second direction, and includes a first conductive pattern and a first conductive connection line alternately arranged along the second direction, the first conductive connection line is connected to adjacent first conductive patterns, and the first conductive pattern further acts as a gate electrode of the thin film transistor; and a common electrode.

### TECHNICAL FIELD

The present disclosure relates to the field of display technology, in particular to an array substrate and a display panel.

### BACKGROUND

In a liquid crystal display (LCD), an array substrate is a main component. In the array substrate, pixel units are arranged in an array, each pixel unit may include a thin film transistor (TFT) and a pixel electrode, and the TFT is connected to a data line and a gate line to drive the pixel electrode in each pixel unit.

The array substrate further includes a common electrode. When an electric field is generated between the pixel electrode and the common electrode, liquid crystals in the pixel unit where the pixel electrode is located are driven to rotate. However, an edge region of an orthographic projection of the common electrode on a base substrate overlaps with an orthographic projection of a gate line on the base substrate. That is, the electric field is disordered at the edge of the common electrode and near the gate line, so that the arrangement of the liquid crystals in the region is disordered, and the liquid crystals are not easy to recover after being pressed, thereby generating the Trace Mura def+ect.

### SUMMARY

The embodiment of the present disclosure provides an array substrate and a display panel.

In a first aspect, the embodiment of the present disclosure provides an array substrate, including: a base substrate, wherein the base substrate includes a display region and a peripheral region surrounding the display region, the array substrate includes a plurality of pixel unit groups arranged in the display region along a first direction, each pixel unit group includes a plurality of pixel units arranged along a second direction, and each pixel unit includes a thin film transistor; the array substrate further includes: a plurality of gate lines arranged along the first direction, wherein each gate line extends along the second direction, and includes a first conductive pattern and a first conductive connection line alternately arranged along the second direction, the first conductive connection line is connected to adjacent first conductive patterns, and the first conductive pattern further acts as a gate electrode of the thin film transistor; and a common electrode, wherein an orthographic projection of the common electrode on the base substrate covers at least an orthographic projection of the first conductive connection line on the base substrate.

In some embodiments, the common electrode includes a plurality of first through holes in one-to-one correspondence with at least some thin film transistors, and each thin film transistor further includes an active layer on one side of the gate electrode; and an orthographic projection of each first through hole on the base substrate falls into a region covered by an orthographic projection of an active layer pattern of a corresponding thin film transistor on the base substrate.

In some embodiments, an orthographic projection of each first through hole on the base substrate overlaps with an orthographic projection of an active layer pattern of a corresponding thin film transistor on the base substrate.

In some embodiments, each pixel unit further includes a pixel electrode including a body electrode and a connection electrode, each thin film transistor includes a first electrode and a second electrode, and the connection electrode is connected to a corresponding body electrode and the second electrode of the thin film transistor; and a minimum distance, in the first direction, between the orthographic projection of each first through hole on the base substrate and an orthographic projection of any one body electrode on the base substrate is in a range from 3 μm to 10 μm.

In some embodiments, two gate lines are arranged between every two adjacent pixel unit groups; the array substrate further includes: a plurality of data lines extending in the first direction; in each pixel unit group, every two adjacent pixel units form a pixel unit subgroup, the pixel unit subgroups are in one-to-one correspondence with the plurality of data lines, and the pixel units are connected to the data line corresponding to the pixel unit subgroup including the pixel units; and two pixel units in each pixel unit subgroup are connected to different gate lines.

In some embodiments, the array substrate includes: a first spacing region between two gate lines between any two adjacent pixel unit groups; and the orthographic projection of the common electrode on the base substrate covers an orthographic projection of a part of each data line in the first spacing region on the base substrate.

In some embodiments, the array substrate includes: a first spacing region between two gate lines between any two adjacent pixel unit groups; and the orthographic projection of the common electrode on the base substrate covers an orthographic projection of the first spacing region on the base substrate.

In some embodiments, the array substrate includes: a third spacing region between any two adjacent pixel unit groups; and a ratio of an area, where the orthographic projection of the common electrode on the base substrate overlaps with an orthographic projection of the third spacing region on the base substrate, to an area of the orthographic projection of the third spacing region on the base substrate is in a range from 0.8 to 0.9.

In some embodiments, the gate electrode of the thin film transistor is connected to a corresponding gate line, the first electrode of the thin film transistor is connected to the data line corresponding to the pixel unit, and the second electrode of the thin film transistor is connected to the pixel electrode in the same pixel unit; two pixel electrodes of two pixel units in each pixel unit subgroup are arranged along the second direction; and two thin film transistors of two pixel units in each pixel unit subgroup are arranged along the first direction.

In some embodiments, each pixel unit group corresponds to two gate lines respectively located on two opposite sides of the pixel unit group in the first direction; each pixel unit subgroup includes a first pixel unit and a second pixel unit, and the first pixel unit is on a side of the second pixel unit away from the data line corresponding to the pixel unit subgroup; a thin film transistor of the first pixel unit is a first thin film transistor, a pixel electrode of the first pixel unit is a first pixel electrode, a thin film transistor of the second pixel unit is a second thin film transistor, and a pixel electrode of the second pixel unit is a second pixel electrode; the first pixel electrode includes a first body electrode and a first connection electrode connected to the corresponding first body electrode and a second electrode of the first thin film transistor; the second pixel electrode includes a second body electrode and a second connection electrode connected to the corresponding second body electrode and a second electrode of the second thin film transistor; the first thin film transistor and the second thin film transistor are located on two opposite sides of the second body electrode in the first direction; and the first body electrode and the second body electrode are arranged along the second direction, the first connection electrode and the first thin film transistor are located on a same side of the second body electrode, and the second connection electrode and the second thin film transistor are located on a same side of the second body electrode.

In some embodiments, an area of an orthographic projection of the first connection electrode on the base substrate is greater than that of an orthographic projection of the second connection electrode on the base substrate; and the common electrode further includes: a plurality of second through holes in one-to-one correspondence with at least some first connection electrodes, and an orthographic projection of each second through hole on the base substrate overlaps with an orthographic projection of the corresponding first connection electrode on the base substrate.

In some embodiments, the first connection electrode includes a first connection portion and a second connection portion, an orthographic projection of the second connection portion on the base substrate and an orthographic projection of the gate electrode of the first thin film transistor on the base substrate are arranged along the second direction, the first connection portion is connected to the first body electrode and the second connection portion, and the second connection portion is connected to the second electrode of the first thin film transistor; and the orthographic projection of each second through hole on the base substrate overlaps with an orthographic projection of the corresponding second connection portion on the base substrate.

In some embodiments, the orthographic projection of the second connection portion on the base substrate covers the orthographic projection of the corresponding second through hole on the base substrate.

In some embodiments, a minimum distance between an edge of the orthographic projection of each second through hole on the base substrate and an edge, on the same side as the edge of the orthographic projection of the second through hole on the base substrate, of the orthographic projection of the corresponding second connection portion on the base substrate is in a range from 1.5 μm to 5 μm.

In some embodiments, the orthographic projection of each second through hole on the base substrate, the orthographic projection of the second electrode of the corresponding first thin film transistor on the base substrate, and the orthographic projection of the corresponding second connection portion on the base substrate overlap with each other.

In some embodiments, an overlapping area of the orthographic projection of the common electrode on the base substrate and the orthographic projection of the first connection electrode on the base substrate is equal to an overlapping area of the orthographic projection of the common electrode on the base substrate and the orthographic projection of the second connection electrode on the base substrate.

In some embodiments, each second through hole has an average aperture in a range from 2.5 μm to 10 μm.

In some embodiments, the common electrode includes a plurality of first through holes in one-to-one correspondence with the thin film transistors; an orthographic projection of each first through hole on the base substrate is in a region covered by an orthographic projection of an active layer pattern of the corresponding thin film transistor on the base substrate; and a minimum distance, in the second direction, between the second through hole and the first through hole corresponding to the first thin film transistor connected to the corresponding first connection electrode is in a range from 5 μm to 10 μm.

In some embodiments, any two adjacent pixel unit subgroups include a first pixel unit subgroup and a second pixel unit subgroup; the first thin film transistor in the first pixel unit subgroup is located on a first side of the second body electrode in the first direction, and the second thin film transistor in the first pixel unit subgroup is located on a second side of the second body electrode in the first direction; the first connection electrode of the first pixel unit in the first pixel unit subgroup is located on a first side of the first body electrode in the first direction, and the second connection electrode of the second pixel unit in the first pixel unit subgroup is located on the second side of the second body electrode in the first direction; the first thin film transistor in the second pixel unit subgroup is located on the second side of the second body electrode in the first direction, and the second thin film transistor in the first pixel unit subgroup is located on the first side of the second body electrode in the first direction; the first connection electrode of the first pixel unit in the second pixel unit subgroup is located on a second side of the first body electrode in the first direction, and the second connection electrode of the second pixel unit in the second pixel unit subgroup is located on the first side of the second body electrode in the first direction; and wherein the first side and the second side are two opposite sides in the first direction.

In some embodiments, the array substrate further includes: a plurality of common voltage line groups in one-to-one correspondence with the plurality of pixel unit groups; each common voltage line group includes a second common voltage line extending in the second direction and a plurality of first common voltage lines extending in the first direction; the array substrate includes a second spacing region between the first body electrode and the second body electrode in the same pixel unit subgroup, and the corresponding first common voltage line is in the second spacing region; and the first body electrode and the second body electrode are both double-domain electrodes, each double-domain electrode includes a first domain and a second domain arranged along the first direction, and an orthographic projection of the second common voltage line on the base substrate covers an orthographic projection of a junction of the first domain and the second domain on the base substrate.

In some embodiments, one end of each first common voltage line close to the second connection electrode is electrically connected to the common electrode through a via.

In some embodiments, a difference between storage capacitances corresponding to the first pixel unit and the second pixel unit is less than 1.5 fF.

In some embodiments, a difference between voltage drops at the first pixel unit and the second pixel unit is less than 0.005V.

In a second aspect, an embodiment of the present disclosure provides a display panel, including the array substrate of the first aspect.

In the array substrate provided by the embodiment of the present disclosure, each gate line includes the gate electrode of the thin film transistor and the connection line alternately arranged along the row direction, namely, the first conductive pattern and the first conductive connection line. By increasing the area of the common electrode, the orthographic projection of the common electrode on the base substrate covers the orthographic projection of the first conductive connection line on the base substrate, so that the electric field disorder generated between the edge of the common electrode and the gate line is avoided, the stability of liquid crystals is improved, and the phenomenon of Trace Mura in the display panel is effectively eliminated.

### BRIEF DESCRIPTION OF DRAWINGS

The accompanying drawings, which are provided for further understanding of the present disclosure and constitute a part of this specification, are for explaining the present disclosure together with the embodiments of the present disclosure, but are not intended to limit the present disclosure. In the drawings:

FIG. 1 is a schematic top view of an array substrate in the related art.

FIG. 2 is a layout of a common electrode in the related art.

FIG. 3 is a schematic top view of an array substrate according to an embodiment of the present disclosure.

FIG. 4 is a schematic top view of a region A in FIG. 3.

FIG. 5 is a cross-sectional view taken along a line AA′ in FIG. 4.

FIG. 6 is a layout of a common electrode layer according to an embodiment of the present disclosure.

FIG. 7 is a layout of a first metal layer according to an embodiment of the present disclosure.

FIG. 8 is a layout of an active layer pattern of a thin film transistor according to an embodiment of the present disclosure.

FIG. 9 is a layout of a superimposition of a first metal layer and an active layer pattern of a thin film transistor according to an embodiment of the present disclosure.

FIG. 10 is a layout of a pixel electrode according to an embodiment of the present disclosure.

FIG. 11 is a layout of a superimposition of a first metal layer, an active layer pattern of a thin film transistor, and a pixel electrode according to an embodiment of the present disclosure.

FIG. 12 is a layout of a second metal layer according to an embodiment of the present disclosure.

FIG. 13 is a layout of a superimposition of a first metal layer, an active layer pattern of a thin film transistor, a pixel electrode, and a data line according to an embodiment of the present disclosure.

FIG. 14 is a layout of a passivation layer according to an embodiment of the present disclosure.

FIG. 15 is a layout of a superimposition of a first metal layer, an active layer pattern of a thin film transistor, a pixel electrode, a data line, and a passivation layer according to an embodiment of the present disclosure.

### DESCRIPTION OF THE REFERENCE NUMERALS

A block-shaped common electrode COM′, an outer edge L′ of the block-shaped common electrode, a base substrate 1, a first spacing region N1, and a second spacing region N2; a first metal layer M1, a gate insulating layer GI, an active layer Act, a pixel electrode layer Pix10, a second metal layer M2, a passivation layer PVX and a common electrode layer COM10, a gate line Gate: a first conductive pattern G1, a first conductive connection line G2, a first portion g1, a second portion g2, a third portion g3, a second protrusion pattern z2; a data line Data, a pixel unit group PG, a pixel unit subgroup pg, a first pixel unit subgroup pg1, a second pixel unit subgroup pg2, a first pixel unit 10, and a second pixel unit 20; a pixel electrode Pix: a body electrode p1, a connection electrode p2; a first pixel electrode pix1: a first body electrode p11, a first connection electrode p21, a first connection portion p211, a second connection portion p212; a second pixel electrode pix2: a second body electrode p12, a second connection electrode p22, a third connection portion p221, a fourth connection portion p222; a common electrode COM: a first through hole k1, a second through hole k2; a thin film transistor TFT: a first electrode 41, a second electrode 42, a gate electrode 43, and an active layer pattern 44; a first thin film transistor T1, a second thin film transistor T2; a passivation layer PVX: a via k3; a common voltage line group Lcom: a first common voltage line L1, a second common voltage line L2, a first protrusion pattern z1; and a first direction Y and a second direction X.

### DETAIL DESCRIPTION OF EMBODIMENTS

The embodiments of the present disclosure will be described in detail below with reference to the accompanying drawings. The embodiments of the present disclosure described here are only for illustrating and explaining the present disclosure, but are not intended to limit the present disclosure.

To make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few, not all of, embodiments of the present disclosure. All other embodiments, which can be derived by one of ordinary skill in the art from the described embodiments of the present disclosure without any creative effort, are within the protective scope of the present disclosure.

Unless otherwise defined, technical or scientific terms used in the embodiments of the present disclosure shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Similarly, the term “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

In a liquid crystal display (LCD), an array substrate is a main component. In the array substrate, pixel units are arranged in an array, each pixel unit may include a thin film transistor (TFT) and a pixel electrode, and the TFT is connected to a data line and a gate line to drive the pixel electrode in each pixel unit.

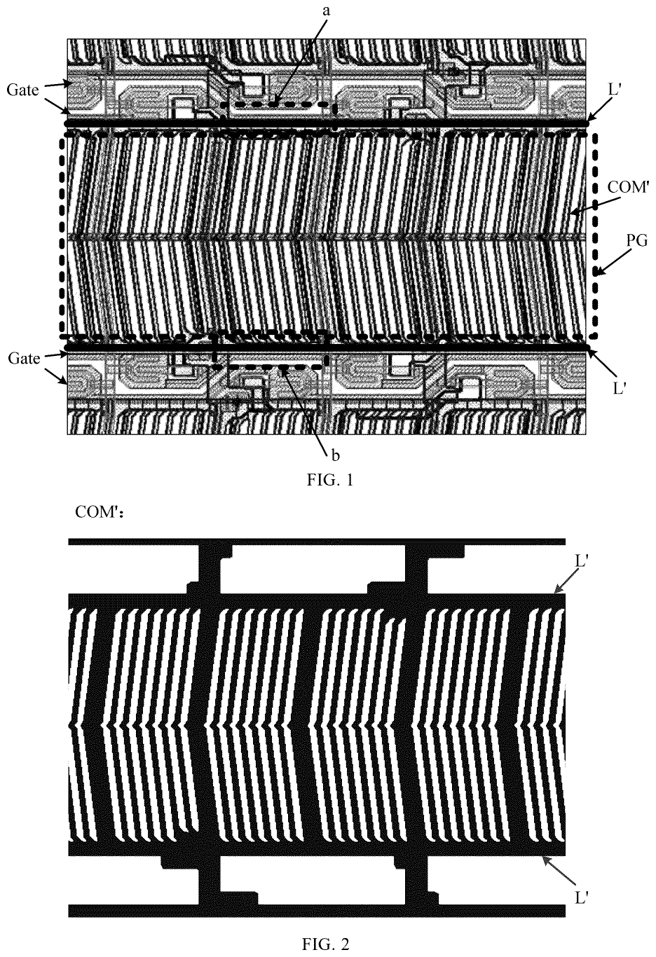

FIG. 1 is a schematic top view of an array substrate in the related art. FIG. 2 is a layout of a common electrode in the related art. As shown in FIGS. 1 and 2, the array substrate includes block-shaped common electrodes COM′. Generally, each block-shaped common electrode COM′ corresponds to one pixel unit group PG, where each pixel unit group PG includes one row of pixel units, and when an electric field is generated between a pixel electrode and the common electrode, liquid crystals in a pixel unit where the pixel electrode is located are driven by the electric field to rotate.

However, the inventor finds in the research that an orthographic projection of the block-shaped common electrode COM′ on a base substrate overlaps with an orthographic projection of a gate line on the base substrate, and a part of an orthographic projection of an outer edge L′ of the block-shaped common electrode COM′ on the base substrate is covered by the orthographic projection of the gate line Gate on the base substrate, as shown at a region a and a region b in FIG. 1. At this time, an electric field between the outer edge L′ of the block-shaped common electrode COM′ and a position in the vicinity of the gate line Gate (for example, in the region a and the region b) is disordered, which causes a disordered alignment of the liquid crystals in the regions and causes that the liquid crystals are hardly restored after being pressed. The electric field disorder region (the region where the electric field is disordered) is close to an opening region of the pixel unit, which affects rotation of the liquid crystals at a position in the opening region close to the electric field disorder region, thereby causing a Trace Mura defect.

In order to solve at least one of the above technical problems, an embodiment of the present disclosure provides an array substrate, which avoids an electric field disorder generated between an edge of a common electrode and a gate line by increasing an area of the common electrode, so as to effectively eliminate a phenomenon of Trace Mura in a display panel.

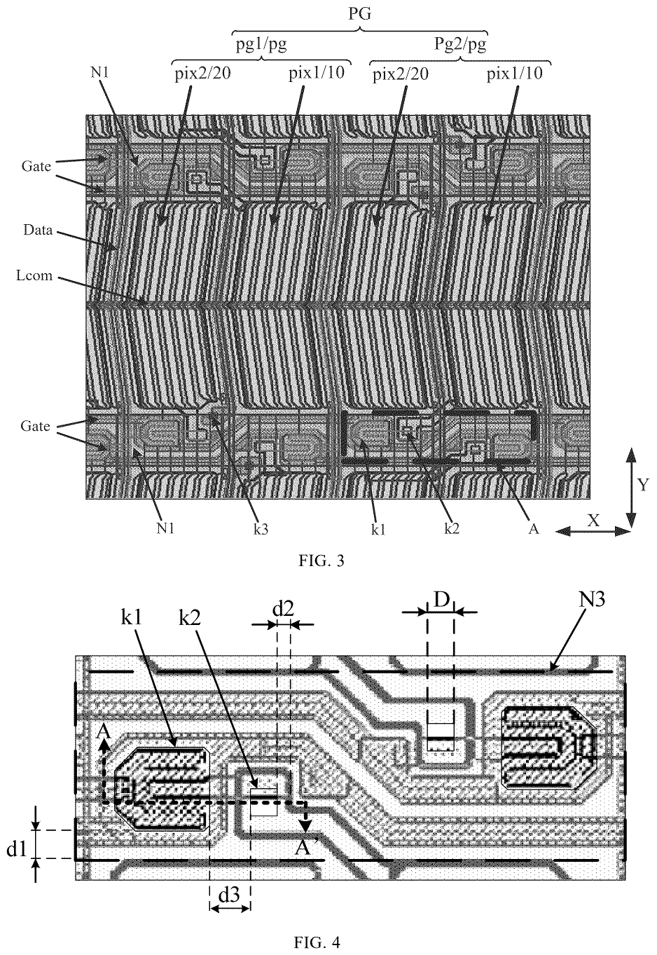

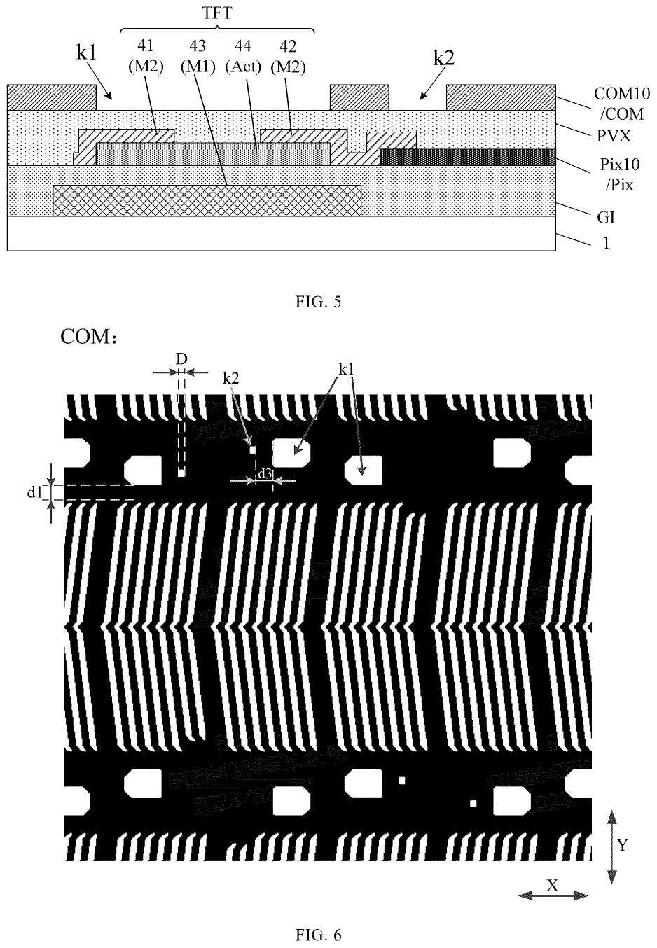

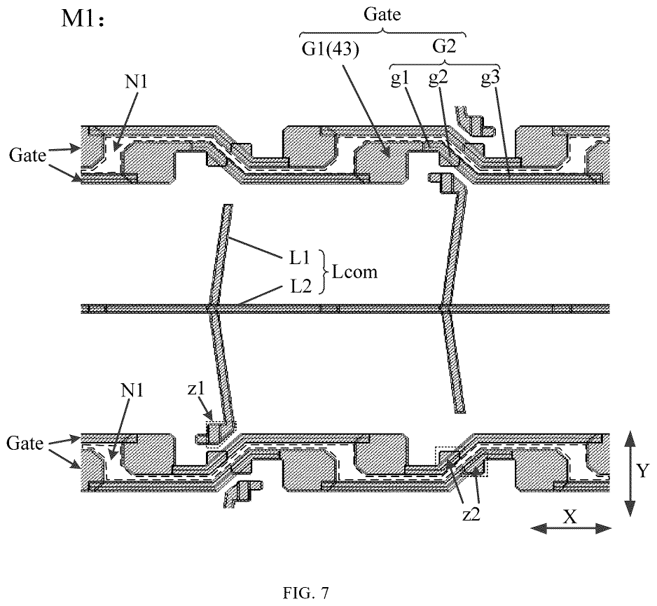

FIG. 3 is a schematic top view of an array substrate according to an embodiment of the present disclosure. FIG. 4 is a schematic top view of a region A in FIG. 3. FIG. 5 is a cross-sectional view taken along a line AA′ in FIG. 4. FIG. 6 is a layout of a common electrode layer according to an embodiment of the present disclosure. FIG. 7 is a layout of a first metal layer according to an embodiment of the present disclosure.

As shown in FIGS. 3 to 7, the array substrate includes: a base substrate 1, wherein the base substrate 1 is divided into a display region (not shown) and a peripheral region (not shown) surrounding the display region, a plurality of pixel unit groups PG are arranged in the display region along a first direction Y, each pixel unit group PG includes a plurality of pixel units arranged along a second direction X, and each pixel unit includes a thin film transistor TFT.

The array substrate further includes: a plurality of gate lines Gate arranged along the first direction Y and a common electrode COM, wherein: each gate line Gate extends along the second direction X, and includes a first conductive pattern G1 and a first conductive connection line G2 alternately arranged along the second direction X, the first conductive connection line G2 is connected to adjacent first conductive patterns G1, and the first conductive pattern G1 further acts as a gate electrode 43 of the thin film transistor. An orthographic projection of the common electrode COM on the base substrate 1 covers at least an orthographic projection of the first conductive connection line G2 on the base substrate 1.

It should be understood that the first direction Y intersects the second direction X, and preferably, the first direction Y is a column direction and the second direction X is a row direction.

In the array substrate provided by the embodiment of the present disclosure, each gate line includes the gate electrode of the thin film transistor and the connection line, namely, the first conductive pattern and the first conductive connection line, alternately arranged along the row direction. By increasing the area of the common electrode, the orthographic projection of the common electrode on the base substrate covers the orthographic projection of the first conductive connection line on the base substrate. That is, the orthographic projection of the outer edge of the common electrode on the base substrate cannot be covered by the orthographic projection of the gate line on the base substrate, so that the electric field disorder generated between the edge of the common electrode and the gate line is avoided, the stability of liquid crystals is improved, and the phenomenon of Trace Mura in the display panel is effectively eliminated.

It should be noted that in a single-gate line array substrate, assuming that the array substrate includes N×M pixel units, the single-gate line array substrate may include N gate lines and M data lines. The pixel units are disposed at intersections of the gate lines and the data lines, and different combinations of the gate lines and the data lines may drive different pixel units. In order to reduce the cost of the product, a dual-gate line array substrate is provided in the prior art. Compared with the single-gate line array substrate, in the dual-gate line array substrate, the number of the data lines can be substantially reduced by half, a cost of a driving circuit connected to the data lines is reduced correspondingly, and therefore a cost of a product can be reduced.

Meanwhile, due to the increase of the number of the gate lines, the phenomenon is aggravated that the electric field disorder is generated by overlapping between the edge of the common electrode and the gate line, which causes the disordered alignment of the liquid crystals, thereby influencing the display effect. Therefore, the array substrate provided by the embodiment of the present disclosure may be suitable for the single-gate line array substrate, and is more particularly suitable for the dual-gate line array substrate.

In the embodiment of the present disclosure, as shown in FIG. 5, a first metal layer M1, a gate insulating layer GI, an active layer Act, a pixel electrode layer Pix10, a second metal layer M2, a passivation layer PVX, and a common electrode layer COM10 are sequentially disposed in a direction away from the base substrate 1. The common electrode layer COM10 includes the common electrode COM, the first metal layer M1 includes gate lines Gate and a common voltage line group Lcom, each gate line Gate includes the first conductive pattern G1 (the gate electrode 43 of the thin film transistor) and the first conductive connection line G2, and a common voltage line in the common voltage line group is connected to the common electrode COM through a via k3 extending through at least the passivation layer PVX. The second metal layer M2 includes data lines Data, a first electrode 41 and a second electrode 42 of each thin film transistor TFT.

It should be understood that one of the first electrode 41 and the second electrode 42 of each thin film transistor TFT is a source electrode of the thin film transistor TFT, and the other one is a drain electrode of the thin film transistor TFT. The pixel electrode layer Pix10 includes a pixel electrode corresponding to each pixel unit, and a body electrode of the pixel electrode has a double-domain structure. Each common electrode COM is a slit electrode extending along the second direction X, and the slits are uniformly distributed.

Unlike the related art shown in FIG. 2 in which the common electrode layer includes a plurality of block-shaped common electrodes COM′ disposed at intervals, as shown in FIG. 6, the common electrode COM included in the common electrode layer COM10 in the embodiment of the present disclosure is a planar electrode.

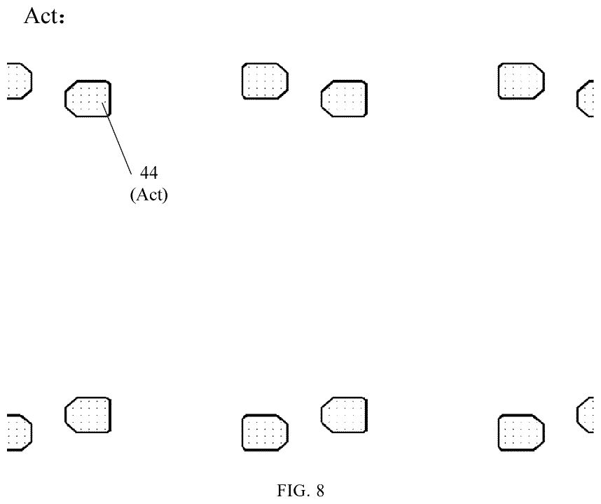

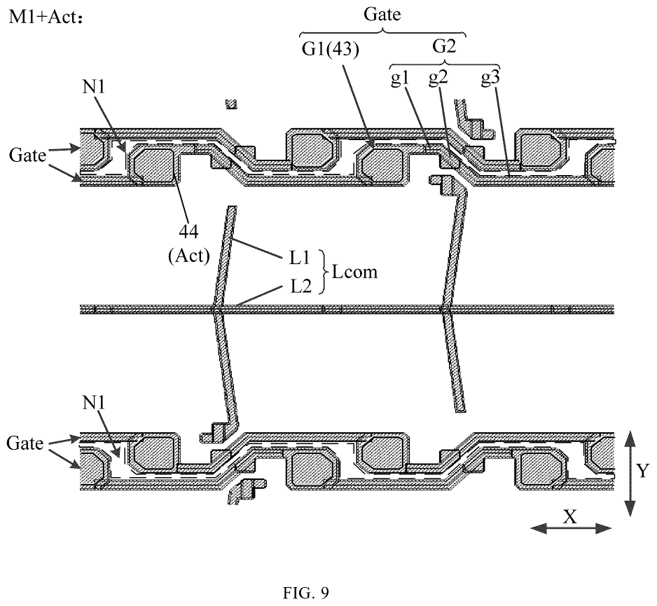

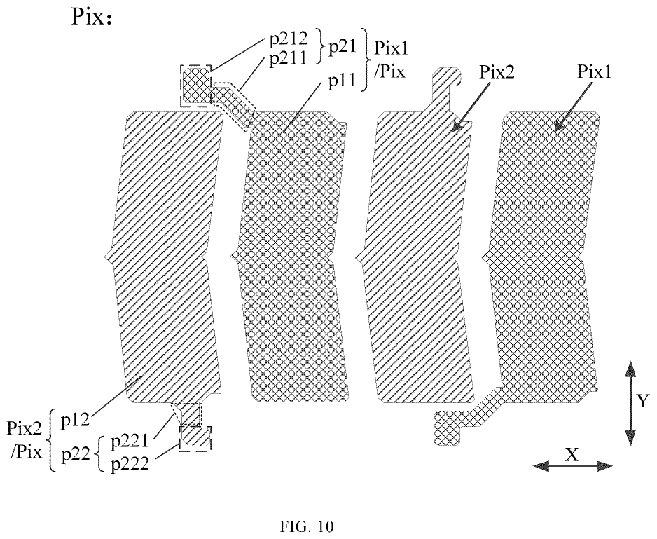

FIG. 8 is a layout of an active layer pattern of a thin film transistor according to an embodiment of the present disclosure. FIG. 9 is a layout of a superimposition of a first metal layer and an active layer pattern of a thin film transistor according to an embodiment of the present disclosure. In some embodiments, as shown in FIGS. 3 to 8, the common electrode COM includes a plurality of first through holes k1 in one-to-one correspondence with at least some of the thin film transistors TFT, and an orthographic projection of each first through hole k1 on the base substrate 1 is located within a region covered by an orthographic projection of an active layer pattern 44 of the corresponding thin film transistor TFT on the base substrate 1.

Preferably, the common electrode COM includes the plurality of first through holes k1 in one-to-one correspondence with all thin film transistors TFT.

Each thin film transistor is configured to generate a driving signal and provide the driving signal to a pixel electrode in a corresponding pixel unit. Particularly, each thin film transistor includes a gate electrode, a source electrode, a drain electrode, and an active layer. The active layer includes a channel portion, and a source connection portion and a drain connection portion on two sides of the channel portion, wherein the source connection portion is connected to the source electrode, the drain connection portion is connected to the drain electrode, and the channel portion is opposite to (directly faces) the gate electrode. When a voltage signal applied to the gate electrode reaches a certain value, a carrier path is formed in the channel portion, so that it turns electrically conducted between the source electrode and the drain electrode of the thin film transistor.

The common electrode COM includes a portion opposite to the active layer pattern 44 of the thin film transistor, which interferes with the formation of the carrier path in the channel portion of the active layer of the thin film transistor, and therefore, affects the generation of the driving signal. Based on this, a pattern of the portion of the common electrode COM opposite to the active layer pattern 44 of the thin film transistor is removed to form the first through holes k1, i.e., the active layer pattern 44 of the thin film transistor is exposed through the first through holes k1, so as to avoid affecting the driving signal.

Preferably, in some embodiments, as shown in FIGS. 3 and 4, the orthographic projection of each first through hole k1 on the base substrate 1 overlaps with an orthographic projection of the active layer pattern 44 of the corresponding thin film transistor on the base substrate 1, so as to avoid a phenomenon that an electric field between an edge of the first through hole and the first conductive connection line G2 of the gate line Gate is disordered due to the too large first through hole k1.

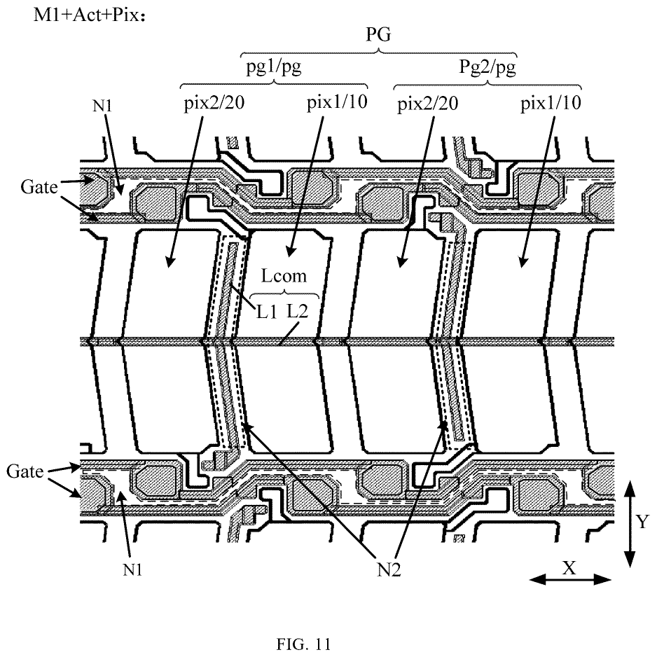

FIG. 10 is a layout of a pixel electrode according to an embodiment of the present disclosure. FIG. 11 is a layout of a superimposition of a first metal layer, an active layer pattern of a thin film transistor, and a pixel electrode according to an embodiment of the present disclosure. In one embodiment, as shown in FIGS. 3, 6, 10, and 11, each pixel unit further includes a pixel electrode Pix, and the pixel electrode Pix includes: a body electrode p1 and a connection electrode p2, the connection electrode p2 is connected to the corresponding body electrode p1 and the second electrode 42 of the thin film transistor TFT; a distance, in the first direction Y, between the orthographic projection of the first through hole k1 on the base substrate 1 and an orthographic projection of any one body electrode p1 on the base substrate 1 is d1, which is in a range from 3 μm to 10 μm.

It should be noted that the pixel unit is provided with an opening region corresponding thereto, and the opening region is a region through which light emitted from the pixel unit may be emitted from the display panel. The body electrode p1 of the pixel electrode Pix is located in the opening region, and an electric field generated between the body electrode p1 and the common electrode COM rotates the liquid crystals, so that the light is emitted.

Based on this, each first through hole k1 is disposed outside the opening region, and a distance d1 between each first through hole k1 and the corresponding body electrode p1 in the first direction Y is not less than 3 μm, so as to avoid affecting the display effect.

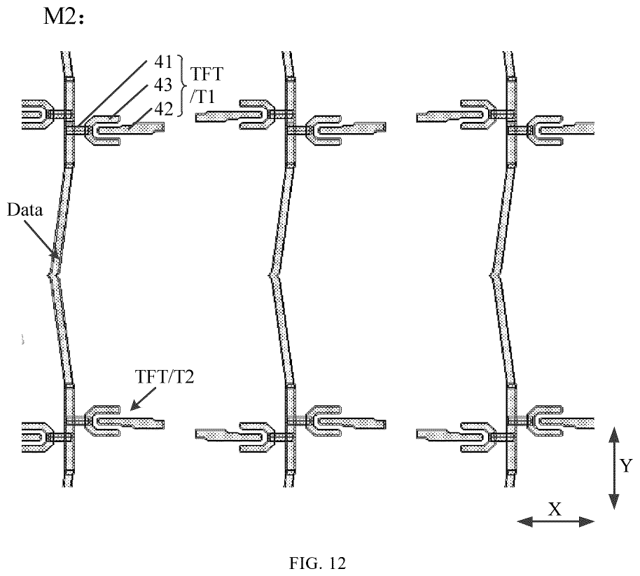

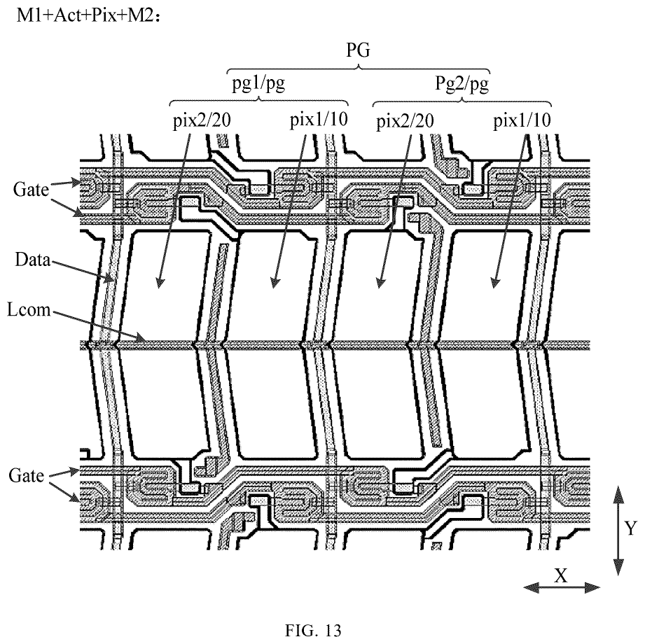

FIG. 12 is a layout of a second metal layer according to an embodiment of the present disclosure. FIG. 13 is a layout of a superimposition of a first metal layer, an active layer pattern of a thin film transistor, a pixel electrode, and a data line according to an embodiment of the present disclosure. In some embodiments, as shown in FIGS. 3, 12 and 13, two gate lines Gate are disposed between any two adjacent pixel unit groups PG. The array substrate further includes: a plurality of data lines Data extending in the first direction Y. In each pixel unit group PG, every two adjacent pixel units form a pixel unit subgroup, the pixel unit subgroups are in one-to-one correspondence with the data lines Data, and the pixel units are connected to the data line Data corresponding to the pixel unit subgroup including the pixel units. Two pixel units in each pixel unit subgroup pg are connected to different gate lines Gate. That is, the array substrate is of a dual-gate line structure. The number of the data lines Data is reduced by increasing the number of the gate lines Gate, so that the cost of the driving circuit connected to the data lines Data is reduced, and the cost of the display product is further reduced.

As shown in FIGS. 3 to 13, a first spacing region N1 is formed between two gate lines Gate, which are positioned between any two adjacent pixel unit groups PG. In some embodiments, the orthographic projection of the common electrode COM on the base substrate 1 covers a portion of the corresponding data line Data in the first spacing region N1, so that the phenomenon can be avoided that the electric field disorder is formed between the edge of the common electrode COM and the data line Data, which affects the display effect.

In some embodiments, the orthographic projection of the common electrode COM on the base substrate 1 covers an orthographic projection of the corresponding first spacing region N1 on the base substrate 1, so that the phenomenon can be avoided that the electric field interference generated between the edge of the common electrode COM and other signal lines causes the disordered arrangement for the liquid crystals and the Trace Mura in the display panel, and therefore the display effect is improved.

In some embodiments, as shown in FIGS. 3 to 13, each pixel unit includes a pixel electrode and a corresponding thin film transistor, the gate electrode 43 of the thin film transistor is connected to the corresponding gate line Gate, the first electrode 41 of the thin film transistor is connected to the corresponding data line Data of the pixel unit, and the second electrode 42 of the thin film transistor is connected to the pixel electrode in the same pixel unit. Two pixel electrodes of two pixel units located in each pixel unit subgroup pg are arranged along the second direction X. The two thin film transistors of the two pixel units located in each pixel unit subgroup pg are arranged along the first direction Y.

Specifically, as shown in FIGS. 3 to 13, each pixel unit group PG corresponds to two gate lines Gate respectively located on two opposite sides of the pixel unit group PG in the first direction Y. Each pixel unit subgroup includes a first pixel unit 10 and a second pixel unit 20, and the first pixel unit 10 is located on a side of the second pixel unit 20 away from the data line Data corresponding to the pixel unit subgroup.

The thin film transistor of the first pixel unit 10 is a first thin film transistor T1, the pixel electrode of the first pixel unit 10 is a first pixel electrode pix1, the thin film transistor of the second pixel unit 20 is a second thin film transistor T2, and the pixel electrode of the second pixel unit 20 is a second pixel electrode pix2. The first pixel electrode pix1 includes a first body electrode p11 and a first connection electrode p21, and the first connection electrode p21 is connected to the corresponding first body electrode p11 and a second electrode 42 of the first thin film transistor T1. The second pixel electrode pix2 includes a second body electrode p12 and a second connection electrode p22, and the second connection electrode p22 is connected to the corresponding second body electrode p12 and a second electrode 42 of the second thin film transistor T2.

As shown in FIGS. 3 to 13, the first thin film transistor T1 and the second thin film transistor T2 are located on opposite sides of the second body electrode p12 in the first direction Y, that is, the first thin film transistor T1, the second body electrode p12, and the second thin film transistor T2 are arranged in the first direction Y. The first body electrode p11 and the second body electrode p12 are arranged in the second direction X, the first connection electrode p21 is positioned on the same side of the second body electrode p12 as the first thin film transistor T1, and the second connection electrode p22 is positioned on the same side of the second body electrode p12 as the second thin film transistor T2.

The first thin film transistor T1 and the second thin film transistor T2 are located on the opposite sides of the second body electrode p12 in the first direction Y, and the first body electrode p11 is located on a side of the second body electrode p12 away from the data line Data in the second direction X, so that an area of the first connection electrode p21 for connecting the first body electrode p11 and the first thin film transistor T1 is greater than an area of the second connection electrode p22 for connecting the second body electrode p12 and the second thin film transistor T2, that is, an area of an orthographic projection of the first connection electrode p21 on the base substrate 1 is greater than an area of an orthographic projection of the second connection electrode p22 on the base substrate 1.

In some embodiments, as shown in FIG. 4, a third spacing region N3 is formed between every two adjacent pixel unit groups PG, and a ratio of an area, where the orthographic projection of the common electrode COM on the base substrate 1 overlaps with an orthographic projection of the third spacing region N3 on the base substrate 1, to an area of the third spacing region N3 is in a range from 0.8 to 0.9. In some embodiments, a ratio of an orthographic projection of a portion of the common electrode COM located in the opening region on the base substrate 1 to an area of the corresponding opening region is in a range from 0.65 to 0.75.

In the embodiment of the present disclosure, by increasing the area of the common electrode COM in the third spacing region N3 between the adjacent pixel unit groups, an orthographic projection of an outer edge of the common electrode COM on the base substrate is not covered by an orthographic projection of the corresponding gate line on the base substrate, so that the electric field disorder generated between the edge of the common electrode and the gate line is prevented, the stability of the liquid crystals is improved, and the Trace Mura in the display panel is effectively eliminated.

Based on the structure of the common electrode COM, a difference between storage capacitances Cst corresponding to the first pixel unit 10 and the second pixel unit 20 is less than 1.5 fF, and a difference between voltage drops generated in the first pixel unit 10 and the second pixel unit 20 is less than 0.005V. See table 1 below for details.

It should be understood that for any one pixel unit, a voltage drop ΔVp at the pixel electrode may be calculated by equation 1:

ΔVp=(Cgs+Cpg)×(Vgh−Vgl)/(Cgs+Cpg+Cst+Clc) Equation 1

Where Cgs is a parasitic capacitance (a gate-source capacitance) generated between the gate electrode and the source electrode of the thin film transistor, Cpg is a parasitic capacitance generated between the pixel electrode and the gate electrode 43, Cst is a storage capacitance generated between the common electrode COM and the pixel electrode, Clc is a liquid crystal capacitance, and Vgh and Vgl are a high-level voltage signal and a low-level voltage signal received at the pixel electrode, respectively.

In any one pixel unit subgroup pg, sizes of the first connection electrode p21 in the first pixel unit 10 and the second connection electrode p22 in the second pixel unit 20 are different from each other, and therefore, an opposite area between the first pixel electrode pix1 and the common electrode COM and an opposite area between the second pixel electrode pix2 and the common electrode COM are different from each other, so that the storage capacitances Cst corresponding to the first pixel unit 10 and the second pixel unit 20 are different from each other, and therefore, voltage drops at the pixel electrodes in the first pixel unit 10 and the second pixel unit 20 are different from each other. Therefore, the brightness difference exists between the first pixel unit 10 and the second pixel unit 20, a phenomenon of “forehead wrinkles” (i.e. a plurality of alternating bright and dark stripes) exists in the whole display panel, and the display effect is affected.

TABLE 1

| | | | The first | The second |
|---|---|---|---|---|
| | | | embodiment | embodiment |
| | | | of the pres- | of the pres- |
| | | Comparative | ent | ent |
| | | embodiment | disclosure | disclosure |
| Driving mode | | Column | | |
| Driving voltage (Vgh/Vgl V) | | 27/−8 | | |
| Cst + Clc | First pixel unit | 312.206 | 355.925 | 359.567 |
| | Second pixel unit | 311.943 | 354.819 | 354.879 |
| Cpg + Cgs | First pixel unit | 24.034 | 22.064 | 22.041 |
| | Second pixel unit | 23.759 | 22.014 | 22.013 |
| ΔVp | First pixel unit | 2.502 | 2.047 | 2.021 |
| | Second pixel unit | 2.477 | 2.045 | 2.044 |

| | | | |
|---|---|---|---|
| ΔVp(pix1) − ΔVp(pix2) | 0.025 | 0.002 | −0.023 |

Table 1 shows a capacitance difference between the first pixel unit 10 and the second pixel unit 20 in each pixel unit subgroup pg for the array substrate in the comparative embodiment and the array substrate in the first embodiment of the present disclosure, the structure of the common electrode COM for the array substrate in the comparative embodiment is shown in FIG. 2, and the common electrode COM covers the spacing region between the adjacent pixel unit groups PG except for the active layer pattern 44 of the thin film transistor in the array substrate of the first embodiment of the present disclosure. The array substrate in the comparative embodiment and the array substrate in the first embodiment of the present disclosure have the same structure except for the common electrode COM, and adopt the same type of the thin film transistor and the same driving mode and provide the same driving voltage to the corresponding pixel electrode.

As above, “the common electrode COM covers the spacing region between the adjacent pixel unit groups PG except for the active layer pattern 44 of the thin film transistor in the array substrate”, which means that the common electrode COM covers a region between the adjacent pixel unit groups PG except for the opening region of the corresponding pixel unit, and the first through hole k1 is provided in the common electrode COM, and an orthographic projection of the first through hole k1 on the base substrate 1 overlaps with an orthographic projection of the active layer pattern 44 of the thin film transistor on the base substrate 1. A main difference between the array substrate in the comparative embodiment and the array substrate in the first embodiment of the present disclosure is the different structure and the different position of the common electrode layer COM10. As shown in table 1, the storage capacitance Cst of the array substrate in the first embodiment of the present disclosure is significantly increased compared to that in the comparative embodiment regardless of the first pixel unit 10 or the second pixel unit 20. In addition, there is no significant difference in the first embodiment of the present disclosure and in the comparative embodiment for each of the gate-source capacitance Cgs, the parasitic capacitance Cpg generated between the pixel electrode and the gate electrode 43, and the liquid crystal capacitance Clc, which is not described in detail in the present disclosure.

In particular, for the array substrate in the comparative embodiment, the structure of the common electrode COM is as shown in FIG. 2, that is, the common electrode COM covers the opening region and an edge region of the pixel unit. That is, the common electrode COM substantially does not cover the spacing region between the adjacent pixel unit groups PG. The first connection electrode p21 corresponding to the first pixel unit 10 and the second connection electrode p22 corresponding to the second pixel unit 20 are located in the spacing region. Therefore, the difference between structures of the pixel electrodes respectively corresponding to the first pixel unit 10 and the second pixel unit 20 does not have a great influence on the overlapping area of the pixel electrode and the common electrode COM in a direction perpendicular to the base substrate 1. The “edge region” refers to a boundary region between the opening region of the pixel unit and the first spacing region N1 between the adjacent pixel unit groups PG, and is located close to the opening region.

It should be further noted that there is a smaller difference between the storage capacitances Cst of the first pixel unit 10 and the second pixel unit 20 in the array substrate in the comparative embodiment, because a via k3 is provided on a side of the second connection electrode p22 away from the second thin film transistor T2 in the second direction X, the common voltage line in the same layer as the gate lines Gate is connected to the common electrode COM through the via k3. The via k3 is located in the edge region of the second pixel unit 20, an orthographic projection of the common electrode COM on the base substrate 1 partially overlaps with an orthographic projection of the via k3 on the base substrate 1. However, no via k3 is provided in the first pixel unit 10, which results in the difference between the storage capacitances Cst of the first pixel unit 10 and the second pixel unit 20.

Similar to a second through hole k2, a shape of the via k3 may be any one of a circle, a quasi-circle, a square, and a rounded square, which is not limited in the embodiment of the present disclosure.

For the array substrate in the first embodiment of the present disclosure, the common electrode COM covers both the third spacing region N3 between the adjacent pixel unit groups PG and the opening region of the pixel unit, so that the area of the common electrode COM is significantly increased, and further the overlapping area of the common electrode COM and the pixel electrode in the direction perpendicular to the base substrate 1 is increased, and therefore, the storage capacitance Cst is significantly increased compared to the array substrate in the comparative embodiment. However, the common electrode COM extends to the spacing region, and areas of the pixel electrodes corresponding to the first pixel unit 10 and the second pixel unit 20 are different, that is, an area of the first connection electrode p21 is greater than that of the second connection electrode p22, so that an overlapping area of the common electrode COM and the first pixel electrode pix1 in the first pixel unit 10 in the direction perpendicular to the base substrate 1 is greater than that of the common electrode COM and the second pixel electrode pix2 in the second pixel unit 20 in the direction perpendicular to the base substrate 1, and further there is a significant difference between the storage capacitances Cst corresponding to the first pixel unit 10 and the second pixel unit 20.

Based on the above and in combination with table 1, the coverage area of the common electrode COM is increased in the embodiment of the present disclosure, so as to avoid the electric field disorder between the edge region of the common electrode COM and the gate line Gate, but voltage drop differences on the pixel electrodes of the first pixel unit 10 and the second pixel unit 20, which are calculated by the above equation 1, in each of the comparative embodiment and the first embodiment of the present disclosure are substantially the same, which may cause the display defect of “forehead wrinkles” in the display panel.

In order to solve the technical problem of the “forehead wrinkles” in the display panel, the embodiment of the present disclosure provides an array substrate. A plurality of second through holes are disposed in the common electrode, to adjust the opposite area of the common electrode and the pixel electrode, thereby to adjust the storage capacitance Cst.

As shown in FIGS. 3 to 13, the common electrode COM further includes: a plurality of second through holes k2 in one-to-one correspondence with at least some of the first connection electrodes p21, and an orthographic projection of each second through hole k2 on the base substrate 1 overlaps with an orthographic projection of the corresponding first connection electrodes p21 on the base substrate 1. Preferably, the common electrode COM includes: a plurality of second through holes k2 in one-to-one correspondence with all of the first connection electrodes p21.

In the array substrate in the embodiment of the present disclosure, the second through holes k2 are disposed in the region of the common electrode COM opposite to the first connection electrode p21, so as to reduce an area of a portion of the common electrode COM opposite to the first connection electrode p21, that is, to reduce the overlapping area of the common electrode COM and the first pixel electrode pix1, further reduce a difference between an overlapping area of the first pixel electrode pix1 and the common electrode COM and an overlapping area of the second pixel electrode pix2 and the common electrode COM, and eliminate the difference between the storage capacitances Cst of the first pixel unit 10 and the second pixel unit 20, so as to eliminate the “forehead wrinkles” in the display panel, and improve the display effect.

The overlapping area refers to an area of a portion where an orthographic projection of the pixel electrode (that is, the first pixel electrode pix1/the second pixel electrode pix2) on the base substrate 1 overlaps with an orthographic projection of the common electrode COM on the base substrate 1.

In some embodiments, as shown in FIGS. 10 and 11, the first connection electrode p21 includes a first connection portion p211 and a second connection portion p212, an orthographic projection of the second connection portion p212 on the base substrate 1 and an orthographic projection of the gate electrode 43 of the first thin film transistor T1 on the base substrate 1 are arranged along the second direction X, the first connection portion p211 is connected to the first body electrode p11 and the second connection portion p212, and the second connection portion p212 is connected to the second electrode 42 of the first thin film transistor T1, and an orthographic projection of each second through hole k2 on the base substrate 1 overlaps with the orthographic projection of the corresponding second connection portion p212 on the base substrate 1.

It should be understood that the second connection portion p212 is wider and has a greater overall area than the first connection portion p211. In this case, the second through hole k2 is provided in a portion of the common electrode COM opposite to the corresponding first connection portion p211, a width of the first connection portion p211 may be smaller than an aperture (a size) of the second through hole k2, so that the orthographic projection of the first connection portion p211 on the base substrate 1 cannot completely cover the orthographic projection of the corresponding second through hole k2 on the base substrate 1. That is, even if the second through hole k2 is provided, a hollow portion of the second through hole k2 cannot be sufficiently used to reduce the overlapping area of the common electrode COM and the corresponding first connection electrode p21. Therefore, the second through hole k2 is provided in a portion of the common electrode COM corresponding to the second connection portion p212, which can ensure that the overlapping area of the common electrode COM and the first connection electrode p21 is effectively reduced.

In addition, the second connection portion p212 is located on a side of the corresponding first connection portion p211 away from the corresponding first body electrode p11, and the first body electrode p11 is located in the opening region of the first pixel unit 10, the second connection portion p212 is farther from the opening region than the first connection portion p211. Therefore, the second through holes k2 are provided in the portion of the common electrode COM corresponding to the second connection portion p212, which can ensure that the formation of the second through holes k2 does not affect the display effect. In addition, an area of the second connection portion p212 is greater than that of the first connection portion p211, so that a difficulty of a hole digging process can be reduced, the accuracy of the hole digging process can be improved, and the effective formation of the second through holes k2 can be ensured.

Preferably, in some embodiments, the orthographic projection of the second connection portion p212 on the base substrate 1 covers the orthographic projection of the corresponding second through hole k2 on the base substrate 1, so that the hollow portion of the second through hole k2 sufficiently reduces the overlapping area of the common electrode COM and the corresponding first connection electrode p21, which can ensure that the overlapping area is effectively reduced. That is, the difference between the overlapping area of the first pixel electrode pix1 and the common electrode COM and the overlapping area of the second pixel electrode pix2 and the common electrode COM is reduced, the difference between the storage capacitances Cst corresponding to the first pixel unit 10 and the second pixel unit 20 is eliminated, and the difference between the voltage drops at the pixel electrodes corresponding to the first pixel unit 10 and the second pixel unit 20 is further reduced, thereby eliminating the “forehead wrinkles” in the display panel, and improving the display effect.

In some embodiments, the overlapping area of the common electrode COM and the first connection electrode p21 in the direction perpendicular to the base substrate 1 is equal to that of the common electrode COM and the second connection electrode p22 in the direction perpendicular to the base substrate 1. Meanwhile, an area of the orthographic projection of the first body electrode p11 on the base substrate 1 is the same as that of the orthographic projection of the second body electrode p12 on the base substrate 1. Therefore, the overlapping area of the common electrode COM and the first pixel electrode pix1 in the direction perpendicular to the base substrate 1 is equal to that of the common electrode COM and the second pixel electrode pix2 in the direction perpendicular to the base substrate 1, so that the storage capacitances Cst in the first pixel unit 10 and the second pixel unit 20 are substantially the same, the difference between the voltage drops at the pixel electrodes corresponding to the first pixel unit 10 and the second pixel unit 20 is further reduced, thereby eliminating the “forehead wrinkles” in the display panel, and improving the display effect.

Continuing to refer to table 1, table 1 further shows a capacitance difference between the first pixel unit 10 and the second pixel unit 20 in each pixel unit subgroup pg for the array substrate in the second embodiment. The structure of the common electrode COM for the array substrate in the second embodiment is shown in FIG. 6. That is, the common electrode COM covers both the opening region of the pixel unit and the region between the adjacent pixel unit groups PG, and the first through holes k1 and the second through holes k2 are provided in the common electrode COM. The orthographic projection of the first through hole k1 on the base substrate 1 overlaps with the orthographic projection of the active layer pattern 44 of the corresponding thin film transistor on the base substrate 1, and the orthographic projection of the second connection portion p212 of the first pixel electrode pix1 on the base substrate 1 covers the orthographic projection of the corresponding second through hole k2 on the base substrate 1. The array substrates in the comparative embodiment, the first embodiment and the second embodiment of the present disclosure have the same structure except for the common electrode COM.

Specifically, as shown in table 1, by providing the second through holes k2 in the common electrode COM to adjust the overlapping area of the first pixel electrode pix1 and the common electrode COM and the overlapping area of the second pixel electrode pix2 and the common electrode COM, the difference between the storage capacitances Cst respectively corresponding to the first pixel unit 10 and the second pixel unit 20 is significantly reduced compared to the first embodiment. Further, the difference between the voltage drops at the pixel electrodes of the first pixel unit 10 and the second pixel unit 20 calculated by the above equation 1 is only 0.002V, which is also significantly reduced compared to the first embodiment, so that the phenomenon of “forehead wrinkles” in the display panel is avoided, and the display effect is improved.

In addition, the array substrate in the comparative embodiment, the array substrate in the first embodiment of the present disclosure and the array substrate in the second embodiment of the present disclosure have the same structure except for the common electrode COM, and adopt the same type of the thin film transistor and the same driving mode and provide the same driving voltage to the corresponding pixel electrode.

In some embodiments, as shown in FIG. 10, the second connection electrode p22 includes a third connection portion p221 and a fourth connection portion p222, and an orthographic projection of the fourth connection portion p222 on the base substrate 1 and an orthographic projection of a gate electrode 43 of the second thin film transistor T2 on the base substrate 1 are arranged along the second direction X, the third connection portion p221 is connected to the second body electrode p12 and the fourth connection portion p222, and the fourth connection portion p222 is connected to the second electrode 42 of the second thin film transistor T2.

In some embodiments, as shown in FIG. 4, a distance d2 between an edge of the orthographic projection of the second through hole k2 on the base substrate 1 and an edge, on the same side as the edge of the orthographic projection of the second through hole k2 on the base substrate 1, of the orthographic projection of the corresponding second connection portion p212 on the base substrate 1 is in a range from 1.5 μm to 5 μm. For example, d2 may be any one of 1.5 μm, 2 μm, 2.5 μm, 3 μm, 3.5 μm, 4 μm, or other value, which is not specifically limited in the present disclosure.

In some embodiments, as shown in FIG. 6, an average aperture D of the second through hole k2 is in a range from 2.5 μm to 10 μm. For example, D may be any one of 2.5 μm, 3 μm, 4 μm, 5 μm, 6 μm, 7 μm, or other value, which is not limited in the present disclosure. It should be understood that a shape of the second through hole may be any one of a circle, a quasi-circle, a square, and a square with rounded corners. The average aperture of the through hole refers to an average value of the maximum hole dimension and the minimum hole dimension passing through a geometric center of the through hole. For example: when the shape of the second through hole is a circle, the average aperture is a diameter of the circle. When the shape of the second through hole is a square, the maximum hole dimension is a diagonal length of the second through hole, the minimum hole dimension is a side length of the second through hole, and the average aperture is an average value of the diagonal length and the side length of the second through hole. When the shape of the second through hole is an ellipse, the average aperture is an average value of a major axis and a minor axis of the ellipse. The average aperture of the second through hole is not limited in the present disclosure.

In some embodiments, the orthographic projection of the second through hole k2 on the base substrate 1, the orthographic projection of the second electrode 42 of the corresponding first thin film transistor T1 on the base substrate 1, and the orthographic projection of the corresponding second connection portion p212 on the base substrate 1 overlap with each other.

In some embodiments, the common electrode COM includes a plurality of first through holes k1 in one-to-one correspondence with the thin film transistors.

An orthographic projection of each first through hole k1 on the base substrate 1 is in a region covered by an orthographic projection of the active layer pattern 44 of the corresponding thin film transistor on the base substrate 1, and a minimum distance d3, in the second direction X, between the second through hole k2 and the first through hole k1 corresponding to the first thin film transistor T1 connected to the corresponding first connection electrode p21 is in a range from 5 μm to 10 μm.

In some embodiments, two adjacent pixel unit subgroups include a first pixel unit subgroup pg1 and a second pixel unit subgroup pg2.

The first thin film transistor T1 in the first pixel unit subgroup pg1 is located on a first side of the second body electrode p12 in the first direction Y, and the second thin film transistor T2 in the first pixel unit subgroup pg1 is located on a second side of the second body electrode p12 in the first direction Y. The first connection electrode p21 of the first pixel unit 10 in the first pixel unit subgroup pg1 is located on a first side of the first body electrode p11 in the first direction Y, and the second connection electrode p22 of the second pixel unit 20 in the first pixel unit subgroup pg1 is located on the second side of the second body electrode p12 in the first direction Y.

The first thin film transistor T1 in the second pixel unit subgroup pg2 is located on the second side of the second body electrode p12 in the first direction Y, and the second thin film transistor T2 in the second pixel unit subgroup pg2 is located on the first side of the second body electrode p12 in the first direction Y. The first connection electrode p21 of the first pixel unit 10 in the second pixel unit subgroup pg2 is located on a second side of the first body electrode p11 in the first direction Y, and the second connection electrode p22 of the second pixel unit 20 in the second pixel unit subgroup pg2 is located on the first side of the second body electrode p12 in the first direction Y.

The first side and the second side are opposite sides in the first direction Y.

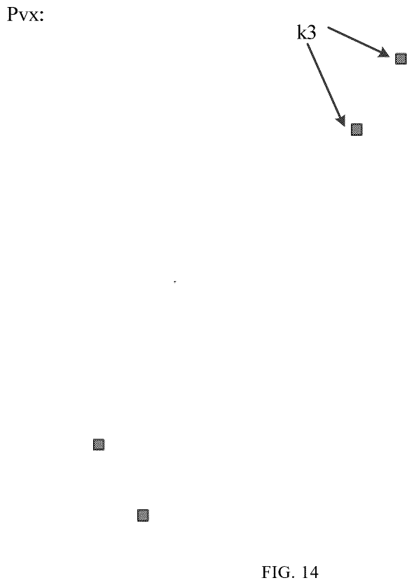

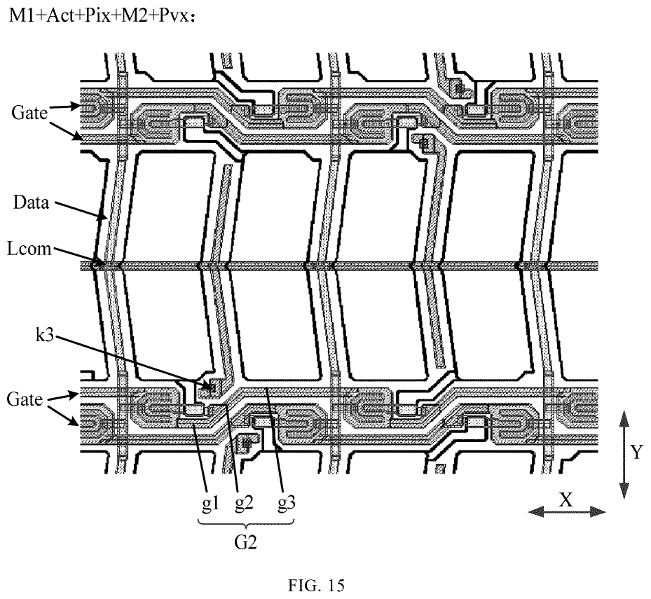

FIG. 14 is a layout of a passivation layer according to an embodiment of the present disclosure. FIG. 15 is a layout of a superimposition of a first metal layer, an active layer pattern of a thin film transistor, a pixel electrode, a data line, and a passivation layer according to an embodiment of the present disclosure. In some embodiments, as shown in FIGS. 3, 7, 9, 11, 13, and 15, in some embodiments, the array substrate further includes: a plurality of common voltage line groups Lcom in one-to-one correspondence with the pixel unit groups PG and in the same layer as the gate lines Gate. Each common voltage line group Lcom includes a second common voltage line L2 extending in the second direction X and a plurality of first common voltage lines L1 extending in the first direction Y.

Specifically, as shown in FIG. 11, a second spacing region N2 is formed between the first body electrode p11 and the second body electrode p12 located in the same pixel unit subgroup pg, and the corresponding first common voltage line L1 is located in the second spacing region N2. The first body electrode p11 and the second body electrode p12 are both double-domain electrodes, each double-domain electrode includes a first domain and a second domain arranged along the first direction Y, and an orthographic projection of the second common voltage line L2 on the base substrate 1 covers an orthographic projection of a junction of the first domain and the second domain on the base substrate 1.

By providing the cross-wise common voltage lines extending through the opening region of the pixel unit and the column-wise common voltage lines between two columns of pixel units located between adjacent data lines Data, the uniformity of the common voltage loaded on the pixel units can be improved.

In some embodiments, as shown in FIGS. 7, 14, and 15, a first protrusion pattern z1 is provided at one end of the first common voltage line L1 close to the second connection electrode p22, and is electrically connected to the common electrode COM through a via k3 extending through the gate insulating layer GI and the passivation layer PVX.

As shown in FIG. 15, the first conductive connection line G2 includes a first portion g1, a second portion g2 and a third portion g3 which are arranged along the second direction X and are connected sequentially, wherein the first portion g1 and the third portion g3 extend along the second direction X, and are connected to different first conductive patterns G1. In the second direction X, an orthographic projection of the via k3 on the base substrate 1 is located between an orthographic projection of the second portion g2 on the base substrate 1 and an orthographic projection of the second connection electrode p22 on the base substrate 1.

In addition, as shown in FIG. 7, a second protrusion pattern z2 is disposed in the second portion g2 for compensating for the gate-source capacitance Cgs in the corresponding thin film transistor. Specifically, the second electrode 42 of the thin film transistor is connected to the first connection electrode p21 of the first pixel electrode pix1, and extends to a region opposite to the second protrusion pattern z2, so that the opposite area of the second electrode 42 and the gate line Gate in the direction perpendicular to the base substrate is increased. With such an arrangement, even if the gate electrode 43 (the first conductive pattern G1) is shifted, the opposite area of the gate line Gate and the second electrode 42 in the direction perpendicular to the base substrate can be still ensured to be not reduced, and the consistency of the gate-source capacitance Cgs is ensured, thereby avoiding the difference between the voltage drops generated at the pixel electrodes. The second electrode 42 is a source electrode of the thin film transistor.

Based on the same inventive concept, embodiments of the present disclosure further provide a display panel, which includes an array substrate, where the array substrate includes the array substrate provided in the foregoing embodiments, and for the description of the array substrate, reference may be made to the contents in the foregoing embodiments, and details are not repeated here.

The display panel provided by the embodiment of the present disclosure may further include an opposite substrate aligned and assembled with the array substrate, a liquid crystal layer and a plurality of spacers are arranged between the array substrate and the opposite substrate, wherein the spacers are located in the spacing region between the opening regions of the adjacent pixel units, and are used for supporting a cell gap of the liquid crystal cell to prevent the display panel from deforming, and the spacers may be formed on the array substrate or the opposite substrate.

The opposite substrate may include a base, and a black matrix and an array of color filters on the base, where color filter patterns in the array of color filters are in one-to-one correspondence with the pixel units, so as to implement the color display.

The embodiment of the present disclosure further provides a display apparatus, which includes the display panel.

The display apparatus provided by the embodiment of the present disclosure may be: any product or component with a display function, such as a wearable apparatus, a mobile phone, a tablet computer, a television, a display, a notebook computer, a digital photo frame, a navigator or the like. Other essential components of the display apparatus are understood by one of ordinary skill in the art to exist, and are not described herein and should not be used to limit the present disclosure.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. An array substrate, comprising: a base substrate, wherein the base substrate comprises a display region and a peripheral region surrounding the display region, the array substrate comprises a plurality of pixel unit groups arranged in the display region along a first direction, each pixel unit group comprises a plurality of pixel units arranged along a second direction, and each pixel unit comprises a thin film transistor;
the array substrate further comprises:
a plurality of gate lines arranged along the first direction, wherein each gate line extends along the second direction, and comprises a first conductive pattern and a first conductive connection line alternately arranged along the second direction, the first conductive connection line is connected to adjacent first conductive patterns, and the first conductive pattern further acts as a gate electrode of the thin film transistor; and
a common electrode, wherein an orthographic projection of the common electrode on the base substrate covers at least an orthographic projection of the first conductive connection line on the base substrate.

2. The array substrate of claim 1, wherein the common electrode comprises a plurality of first through holes in one-to-one correspondence with at least some thin film transistors, and each thin film transistor further comprises an active layer on one side of the gate electrode; and
an orthographic projection of each first through hole on the base substrate falls into a region covered by an orthographic projection of an active layer pattern of a corresponding thin film transistor on the base substrate.

3. The array substrate of claim 2, wherein an orthographic projection of each first through hole on the base substrate overlaps with an orthographic projection of an active layer pattern of a corresponding thin film transistor on the base substrate.

4. The array substrate of claim 2, wherein each pixel unit further comprises a pixel electrode comprising a body electrode and a connection electrode, each thin film transistor comprises a first electrode and a second electrode, and the connection electrode is connected to a corresponding body electrode and the second electrode of the thin film transistor; and
a minimum distance, in the first direction, between the orthographic projection of each first through hole on the base substrate and an orthographic projection of any one body electrode on the base substrate have is in a range from 3 μm to 10 μm.

5. The array substrate of claim 4, wherein two gate lines are arranged between every two adjacent pixel unit groups;
the array substrate further comprises: a plurality of data lines extending in the first direction;
in each pixel unit group, every two adjacent pixel units form a pixel unit subgroup, the pixel unit subgroups are in one-to-one correspondence with the plurality of data lines, and the pixel units are connected to the data line corresponding to the pixel unit subgroup comprising the pixel units; and
two pixel units in each pixel unit subgroup are connected to different gate lines.

6. The array substrate of claim 5, wherein the array substrate comprises: a first spacing region between two gate lines between any two adjacent pixel unit groups; and
the orthographic projection of the common electrode on the base substrate covers an orthographic projection of a part of each data line in the first spacing region on the base substrate, or
the array substrate comprises: a first spacing region between two gate lines between any two adjacent pixel unit groups; and the orthographic projection of the common electrode on the base substrate covers an orthographic projection of the first spacing region on the base substrate.

7. (canceled)

8. The array substrate of claim 5, wherein the array substrate comprises: a third spacing region between any two adjacent pixel unit groups; and
a ratio of an area, where the orthographic projection of the common electrode on the base substrate overlaps with an orthographic projection of the third spacing region on the base substrate, to an area of the orthographic projection of the third spacing region on the base substrate is in a range from 0.8 to 0.9.

9. The array substrate of claim 5, wherein
the gate electrode of the thin film transistor is connected to a corresponding gate line, the first electrode of the thin film transistor is connected to the data line corresponding to the pixel unit, and the second electrode of the thin film transistor is connected to the pixel electrode in the same pixel unit;
two pixel electrodes of two pixel units in each pixel unit subgroup are arranged along the second direction; and
two thin film transistors of two pixel units in each pixel unit subgroup are arranged along the first direction.

10. The array substrate of claim 9, wherein each pixel unit group corresponds to two gate lines respectively located on two opposite sides of the pixel unit group in the first direction;
each pixel unit subgroup comprises a first pixel unit and a second pixel unit, and the first pixel unit is on a side of the second pixel unit away from the data line corresponding to the pixel unit subgroup;
a thin film transistor of the first pixel unit is a first thin film transistor, a pixel electrode of the first pixel unit is a first pixel electrode, a thin film transistor of the second pixel unit is a second thin film transistor, and a pixel electrode of the second pixel unit is a second pixel electrode;
the first pixel electrode comprises a first body electrode and a first connection electrode connected to the corresponding first body electrode and a second electrode of the first thin film transistor;
the second pixel electrode comprises a second body electrode and a second connection electrode connected to the corresponding second body electrode and a second electrode of the second thin film transistor;
the first thin film transistor and the second thin film transistor are located on two opposite sides of the second body electrode in the first direction; and
the first body electrode and the second body electrode are arranged along the second direction, the first connection electrode and the first thin film transistor are located on a same side of the second body electrode, and the second connection electrode and the second thin film transistor are located on a same side of the second body electrode.

11. The array substrate of claim 10, wherein an area of an orthographic projection of the first connection electrode on the base substrate is greater than that of an orthographic projection of the second connection electrode on the base substrate; and
the common electrode further comprises: a plurality of second through holes in one-to-one correspondence with at least some first connection electrodes, and an orthographic projection of each second through hole on the base substrate overlaps with an orthographic projection of the corresponding first connection electrode on the base substrate.

12. The array substrate of claim 11, wherein the first connection electrode comprises a first connection portion and a second connection portion, an orthographic projection of the second connection portion on the base substrate and an orthographic projection of the gate electrode of the first thin film transistor on the base substrate are arranged along the second direction, the first connection portion is connected to the first body electrode and the second connection portion, and the second connection portion is connected to the second electrode of the first thin film transistor; and
the orthographic projection of each second through hole on the base substrate overlaps with an orthographic projection of the corresponding second connection portion on the base substrate.

13. The array substrate of claim 12, wherein the orthographic projection of the second connection portion on the base substrate covers the orthographic projection of the corresponding second through hole on the base substrate; and
a minimum distance between an edge of the orthographic projection of each second through hole on the base substrate and an edge, on the same side as the edge of the orthographic projection of the second through hold on the base substrate, of the orthographic projection of the corresponding second connection portion on the base substrate is in a range from 1.5 μm to 5 μm.

14. (canceled)

15. The array substrate of claim 12, wherein the orthographic projection of each second through hole on the base substrate, the orthographic projection of the second electrode of the corresponding first thin film transistor on the base substrate, and the orthographic projection of the corresponding second connection portion on the base substrate overlap with each other.

16. The array substrate of claim 11, wherein an overlapping area of the orthographic projection of the common electrode on the base substrate and the orthographic projection of the first connection electrode on the base substrate is equal to an overlapping area of the orthographic projection of the common electrode on the base substrate and the orthographic projection of the second connection electrode on the base substrate.

17. The array substrate of claim 9, wherein each second through hole has an average aperture in a range from 2.5 μm to 10 μm.

18. The array substrate of claim 11, wherein the common electrode comprises a plurality of first through holes in one-to-one correspondence with the thin film transistors;
an orthographic projection of each first through hole on the base substrate is in a region covered by an orthographic projection of an active layer pattern of the corresponding thin film transistor on the base substrate; and
a minimum distance, in the second direction, between the second through hole and the first through hole corresponding to the first thin film transistor connected to the corresponding first connection electrode is in a range from 5 μm to 10 μm.

19. The array substrate of claim 10, wherein any two adjacent pixel unit subgroups comprise a first pixel unit subgroup and a second pixel unit subgroup;
the first thin film transistor in the first pixel unit subgroup is located on a first side of the second body electrode in the first direction, and the second thin film transistor in the first pixel unit subgroup is located on a second side of the second body electrode in the first direction;
the first connection electrode of the first pixel unit in the first pixel unit subgroup is located on a first side of the first body electrode in the first direction, and the second connection electrode of the second pixel unit in the first pixel unit subgroup is located on the second side of the second body electrode in the first direction;
the first thin film transistor in the second pixel unit subgroup is located on the second side of the second body electrode in the first direction, and the second thin film transistor in the second pixel unit subgroup is located on the first side of the second body electrode in the first direction;
the first connection electrode of the first pixel unit in the second pixel unit subgroup is located on a second side of the first body electrode in the first direction, and the second connection electrode of the second pixel unit in the second pixel unit subgroup is located on the first side of the second body electrode in the first direction; and
wherein the first side and the second side are two opposite sides in the first direction.

20. The array substrate of claim 10, wherein the array substrate further comprises: a plurality of common voltage line groups in one-to-one correspondence with the plurality of pixel unit groups;
each common voltage line group comprises a second common voltage line extending in the second direction and a plurality of first common voltage lines extending in the first direction;
the array substrate comprises a second spacing region between the first body electrode and the second body electrode in the same pixel unit subgroup, and the corresponding first common voltage line is in the second spacing region; and
the first body electrode and the second body electrode are both double-domain electrodes, each double-domain electrode comprises a first domain and a second domain arranged along the first direction, and an orthographic projection of the second common voltage line on the base substrate covers an orthographic projection of a junction of the first domain and the second domain on the base substrate; and
one end of each first common voltage line close to the second connection electrode is electrically connected to the common electrode through a via.

21. (canceled)

22. The array substrate of claim 10, wherein a difference between storage capacitances corresponding to the first pixel unit and the second pixel unit is less than 1.5 fF; or
a difference between voltage drops at the first pixel unit and the second pixel unit is less than 0.005V.

23. (canceled)

24. A display panel, comprising the array substrate of claim 1.
